(19) United States
(12) Patent Application Publication
(10) Pub. No.: US 2012/0291356 A1
(43) Pub. Date: Nov. 22, 2012

(54) SYNCHRONOUS DRIVE DEVICE FOR SLIDE COVER MECHANISM

(75) Inventors: AN SZU HSU, NEW TAIPEI CITY (TW); YUNG SHENG KUO, NEW TAIPEI CITY (TW)

(73) Assignee: FIRST DOME CORPORATION, NEW TAIPEI CITY (TW)

(21) Appl. No.: 13/109,085

(22) Filed: May 17, 2011

(51) Int. Cl. E05F 11/04

(52) U.S. Cl. 49/360

(57) ABSTRACT

A synchronous drive device for slide cover mechanism includes two guide members, two slide seats and two drive assemblies. Slide guide sections are disposed on each guide member, whereby the slide seats can slide along the slide guide sections. Two rollers are respectively disposed on opposite sides of the slide seats. Each drive assembly includes at least one drive cord. Two ends of the drive cord are respectively diagonally fixed beside two ends of the two guide members on different sides. A middle section of the drive cord passes through the rollers on the slide seats, whereby the two drive cords transversely turn between the slide seats to intersect each other. By means of the driving of the drive cords, the slide seats can synchronously slide along the slide guide sections of the guide member.

### BACKGROUND OF THE INVENTION

1. Field of the Invention

The present invention relates generally to a synchronous drive device for slide cover mechanism, and more particularly to a drive device for slide cover mechanism, which is able to provide stable driving force for the slide cover. With the synchronous drive device, the slide cover can be stably operated without deflection even under single-side lateral push force.

2. Description of the Related Art

In the current market, various slide cover structures have been developed and applied to different electronic devices. For example, Taiwanese Patent Publication No. 1280031 discloses a slide cover device including a substrate with a guide channel and slide rail. The guide channel is formed with a curved path having an overpass point. The slide cover device further includes an upper cover formed with elongated slots and inlaid in the slide rail. The slide cover device further includes elastic members positioned at the elongated slots. The elastic members include two springs and rolling members. The fixed ends of the springs are respectively fixed at the outer ends of the elongated slots. The rolling members are respectively connected with the free ends of the springs, which free ends extend in the elongated slots. When the upper cover is moved, the rolling members move along the guide channel to drivingly compress/decompress the springs. When the rolling members pass over the overpass point, the elastic members will pull the upper cover to automatically extend or retract the upper cover relative to the substrate.

Taiwanese Patent Publication No. M392525 discloses a slide cover assembly and a slide cover electronic device. The slide cover assembly is disposed between the cover body and the main body of the electronic device. The slide cover assembly includes a support board connected with the cover body and a link board connected with the main body. A slide block is disposed in the support board. A torque spring assembly and an elastic member serve to apply a force to the slide block to slide the slide block. The slide block is connected with the link board via connection strings wound on locating poles of the support board. By means of the connection strings, the link board and the slide block always move relative to each other in reverse directions. The flat cable of the electronic device is conducted through the slide block and drivable by the slide block.

Taiwanese Patent Publication No. 1328088 discloses a slide module and a portable electronic device adopting the slide module. The slide module includes a fixed system and a movable system. A fixed frame is fixedly connected to the fixed system and a movable frame is fixedly connected to the movable system. Two reverse hook sections are disposed on two sides of the fixed frame. The lateral edges of the movable frame are fitted and received in the reverse hook sections, whereby the movable system can be moved relative to the fixed system between a first position and a second position. Linear torque springs are used to provide necessary driving force for the movable system.

In the above structure, coil springs or linear metal torque springs are used to provide necessary driving force for the slide cover. Such structure is practically applicable to small-size electronic products with small-volume and lightweight slide cover, such as cellular phones, handheld game machines and personal digital assistants (PDA). However, such structure can be hardly applied to a large-size electronic product such as a laptop computer or a tablet computer. This is because the movable system will have a heavier weight and it is necessary to move the movable system through a longer distance. When applying a push force to one single side of the movable system, the movable system is very likely to be biased. This will affect the smoothness of the sliding movement of the movable system. In some more serious cases, the movable system may be stuck with no possibility of moving. Moreover, it is hard to assemble the elastic members with the driven components. Also, elastic fatigue of the elastic members tends to take place after a period of use. This will lead to unsmooth operation of the slide cover.

### SUMMARY OF THE INVENTION

It is therefore a primary object of the present invention to provide a synchronous drive device for slide cover mechanism. With the synchronous pull device, the slide cover can still stably and smoothly slide without deflection even under one-side lateral push force.

It is a further object of the present invention to provide the above synchronous drive device for slide cover mechanism, in which the components are securely connected with each other without loosening so that the possibility of malfunction is minimized.

It is still a further object of the present invention to provide the above synchronous drive device for slide cover mechanism, which has a simplified structure and is easy to assemble. Therefore, the manufacturing cost of the slide cover is lowered.

To achieve the above and other objects, the synchronous drive device for slide cover mechanism of the present invention includes: two guide members, which are side by side arranged opposite to each other, at least one slide guide section being disposed on each of the guide members; two slide seats respectively connected with the guide members and slidable along the slide guide sections of the guide members, a roller being correspondingly disposed on each of the slide seats; and two drive assemblies each including at least one drive cord. Two ends of the drive cord are diagonally fixed beside two ends of the two guide members on different sides. A middle section of the drive cord passes through the rollers on the slide seats, whereby the two drive cords transversely turn between the slide seats to intersect each other.

In the above synchronous drive device for slide cover mechanism, the rollers are disposed on opposite sides of the slide seats.

In the above synchronous drive device for slide cover mechanism, the guide members are arranged in parallel to each other.

In the above synchronous drive device for slide cover mechanism, two ends of each drive cord are respectively fixed with two support poles.

The present invention can be best understood through the following description and accompanying drawings, wherein:

### BRIEF DESCRIPTION OF THE DRAWINGS

FIG. 1 is a perspective view of the present invention;

FIG. 2 is a plane view showing the operation of the present invention in one state; and

FIG. 3 is a plane view showing the operation of the present invent ion in another state.

### DETAILED DESCRIPTION OF THE PREFERRED EMBODIMENTS

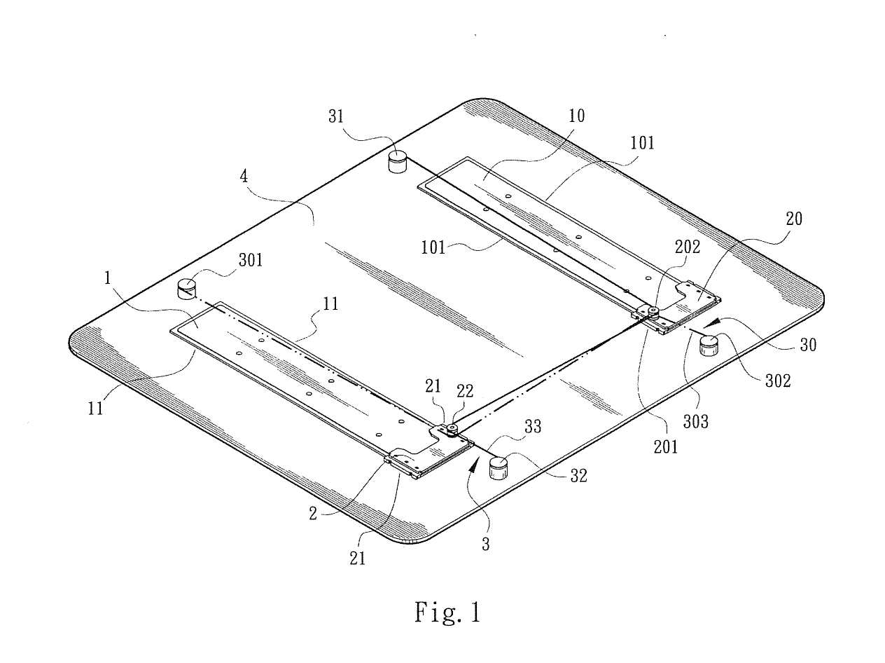

Please refer to FIGS. 1 to 3. The present invention includes two guide members 1, 10, two slide seats 2, 20 and two drive assemblies 3, 30. The guide members 1, 10 are oppositely side by side arranged on a base seat 4 (preferably in parallel to each other). The base seat 4 is connectable with a slide member (such as a slide cover). In practice, the guide members 1, 10 can be directly disposed on the slide member. At least one slide guide section 11, 101 is disposed on each of the guide members 1, 10. Preferably, each of the guide members 1, 10 has two slide guide sections 11, 101 on two sides. The slide seats 2, 20 are formed or arranged on a relative slide member (such as a main body of an electronic device). At least one low-friction slide jacket section 21, 201 is disposed on one side of each of the slide seats 2, 20. Preferably, each of the slide seats 2, 20 has two slide jacket sections 21, 201 on two sides. The slide jacket sections 21, 201 are slidably connected with the slide guide sections 11, 101 of the guide members 1, 10, whereby the slide seats 2, 20 can slide along the slide guide sections 11, 101. In addition, rollers 22, 202 are respectively correspondingly disposed on opposite sides of the slide seats 2, 20. Each of the drive assemblies 3, 30 includes two drive cords 33, 303. One end of the drive cord 33 is fixed beside one end of the guide member 10 via a support pole 31. A middle section of the drive cord 33 passes through the roller 202 of the slide seat 20 and the roller 22 of the slide seat 2. The other end of the drive cord 33 is fixed beside one end of the guide member 1 via a support pole 32, which end is distal from the support pole 31. One end of the drive cord 303 is fixed beside one end of the guide member 1 via a support pole 301, which end is proximal to the support pole 31. (The support pole 301 and the support pole 31 are positioned on the same side). A middle section of the drive cord 303 passes through the roller 22 of the slide seat 2 and the roller 202 of the slide seat 20. The other end of the drive cord 303 is fixed beside one end of the guide member 10 via a support pole 302, which end is proximal to the support pole 32. Accordingly, the two drive assemblies 3, 30 transversely turn between the slide seats 2, 20 to intersect each other.

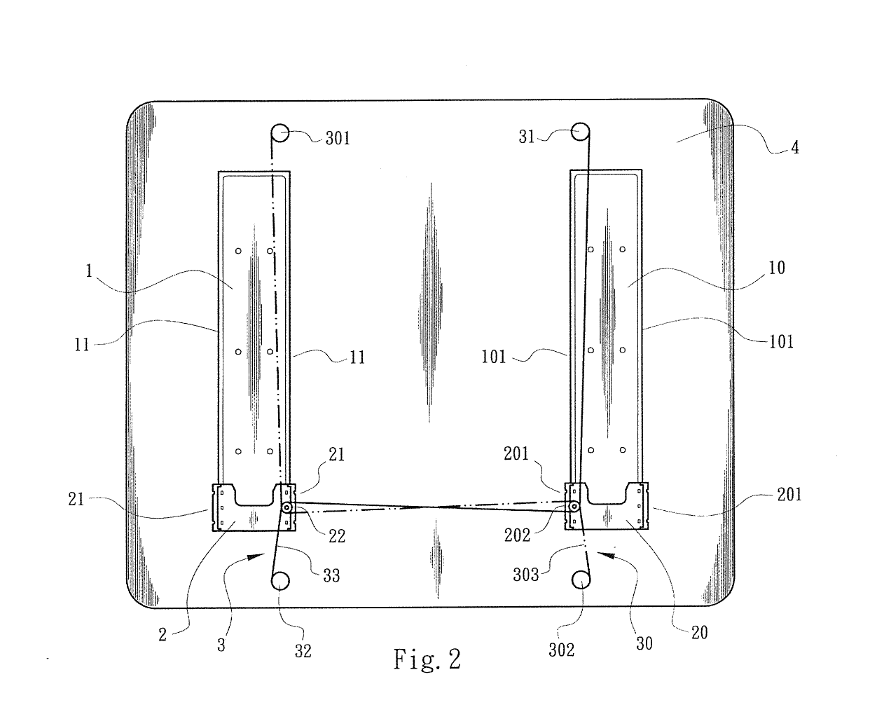

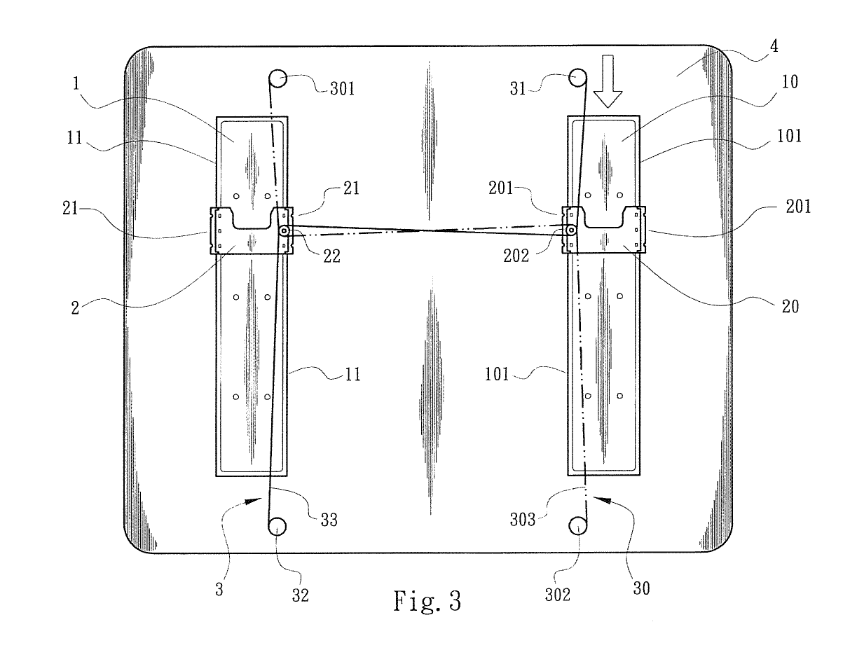

In operation, in the case that the slide seats 2, 20 are initially positioned at one end of the slide guide sections 11, 101 of the guide members 1, 10 (as shown in FIG. 2), when a force is applied to at least one of the slide seats 2, 20 to make the slide seats 2, 20 move toward the other end of the slide guide sections 11, 101 (as shown in FIG. 3), a section of the drive cord 33 between the roller 22 and the support pole 32 is gradually elongated (with the roller 22 rotating counterclockwise). On the contrary, a section of the drive cord 33 between the roller 202 and the support pole is gradually synchronously shortened (with the roller 202 rotating clockwise). In the meantime, a section of the drive cord 303 between the roller 202 and the support pole 302 is gradually elongated (with the roller 202 rotating clockwise) and a section of the drive cord 303 between the roller 22 and the support pole 301 is gradually synchronously shortened (with the roller 22 rotating counterclockwise). Accordingly, the slide seats 2, 20 can synchronously slide. Similarly, when the slide seats 2, 20 are moved in a reverse direction, the slide seats 2, 20 can also synchronously slide.

According to the above arrangement, the slide seats 2, 20 are respectively arranged on the guide members 1, 10 to avoid deflection due to lateral force. Also, the present invention has a simplified structure and is easy to assemble so that the manufacturing cost is lowered. In addition, in use, the present invention is not subject to wear so that the possibility of malfunction is minimized. Accordingly, the quality of the product can be ensured to promote the competitive ability of the product.

The above embodiments are only used to illustrate the present invention, not intended to limit the scope thereof. Many modifications of the above embodiments can be made without departing from the spirit of the present invention.

What is claimed is:

1. A synchronous drive device for slide cover mechanism, comprising:
two guide members, which are side by side arranged opposite to each other, at least one slide guide section being disposed on each of the guide members;
two slide seats respectively connected with the guide members and slidable along the slide guide sections of the guide members, a roller being correspondingly disposed on each of the slide seats; and
two drive assemblies each including at least one drive cord, two ends of the drive cord being diagonally fixed beside two ends of the two guide members on different sides, a middle section of the drive cord passing through the rollers on the slide seats, whereby the two drive cords transversely turn between the slide seats to intersect each other.

2. The synchronous drive device for slide cover mechanism as claimed in claim 1, wherein the rollers are disposed on opposite sides of the slide seats.

3. The synchronous drive device for slide cover mechanism as claimed in claim 1, wherein the guide members are arranged on a base seat in parallel to each other.

4. The synchronous drive device for slide cover mechanism as claimed in claim 2, wherein the guide members are arranged on a base seat in parallel to each other.

5. The synchronous drive device for slide cover mechanism as claimed in claim 3, wherein the guide members are integrally formed on the base seat.

6. The synchronous drive device for slide cover mechanism as claimed in claim 4, wherein the guide members are integrally formed on the base seat.

7. The synchronous drive device for slide cover mechanism as claimed in claim 1, wherein the slide seats are disposed on a relative slide member, which is slidable relative to the guide members.

8. The synchronous drive device for slide cover mechanism as claimed in claim 2, wherein the slide seats are disposed on a relative slide member, which is slidable relative to the guide members.

9. The synchronous drive device for slide cover mechanism as claimed in claim 7, wherein the slide seats are integrally formed on the relative slide member.

10. The synchronous drive device for slide cover mechanism as claimed in claim 8, wherein the slide seats are integrally formed on the relative slide member.

11. The synchronous drive device for slide cover mechanism as claimed in claim 1, wherein each guide member has two slide guide sections respectively disposed on two sides of the guide member in parallel to each other, the slide seats being relatively slidably connected with the slide guide sections.

12. The synchronous drive device for slide cover mechanism as claimed in claim 2, wherein each guide member has two slide guide sections respectively disposed on two sides of the guide member in parallel to each other, the slide seats being relatively slidably connected with the slide guide sections.

13. The synchronous drive device for slide cover mechanism as claimed in claim 3, wherein each guide member has two slide guide sections respectively disposed on two sides of the guide member in parallel to each other, the slide seats being relatively slidably connected with the slide guide sections.

14. The synchronous drive device for slide cover mechanism as claimed in claim 5, wherein each guide member has two slide guide sections respectively disposed on two sides of the guide member in parallel to each other, the slide seats being relatively slidably connected with the slide guide sections.

15. The synchronous drive device for slide cover mechanism as claimed in claim 7, wherein each guide member has two slide guide sections respectively disposed on two sides of the guide member in parallel to each other, the slide seats being relatively slidably connected with the slide guide sections.

16. The synchronous drive device for slide cover mechanism as claimed in claim 9, wherein each guide member has two slide guide sections respectively disposed on two sides of the guide member in parallel to each other, the slide seats being relatively slidably connected with the slide guide sections.

17. The synchronous drive device for slide cover mechanism as claimed in claim 11, wherein slide jacket sections are disposed on each slide seat, the slide jacket sections being slidably fitted with the slide guide sections.

18. The synchronous drive device for slide cover mechanism as claimed in claim 12, wherein slide jacket sections are disposed on each slide seat, the slide jacket sections being slidably fitted with the slide guide sections.

19. The synchronous drive device for slide cover mechanism as claimed in claim 13, wherein slide jacket sections are disposed on each slide seat, the slide jacket sections being slidably fitted with the slide guide sections.

20. The synchronous drive device for slide cover mechanism as claimed in claim 14, wherein slide jacket sections are disposed on each slide seat, the slide jacket sections being slidably fitted with the slide guide sections.

21. The synchronous drive device for slide cover mechanism as claimed in claim 15, wherein slide jacket sections are disposed on each slide seat, the slide jacket sections being slidably fitted with the slide guide sections.

22. The synchronous drive device for slide cover mechanism as claimed in claim 16, wherein slide jacket sections are disposed on each slide seat, the slide jacket sections being slidably fitted with the slide guide sections.

23. The synchronous drive device for slide cover mechanism as claimed in claim 1, wherein two ends of each drive cord are respectively fixed with two support poles.

24. The synchronous drive device for slide cover mechanism as claimed in claim 2, wherein two ends of each drive cord are respectively fixed with two support poles.

25. The synchronous drive device for slide cover mechanism as claimed in claim 3, wherein two ends of each drive cord are respectively fixed with two support poles.

26. The synchronous drive device for slide cover mechanism as claimed in claim 5, wherein two ends of each drive cord are respectively fixed with two support poles.

27. The synchronous drive device for slide cover mechanism as claimed in claim 7, wherein two ends of each drive cord are respectively fixed with two support poles.

28. The synchronous drive device for slide cover mechanism as claimed in claim 9, wherein two ends of each drive cord are respectively fixed with two support poles.

29. The synchronous drive device for slide cover mechanism as claimed in claim 11, wherein two ends of each drive cord are respectively fixed with two support poles.

30. The synchronous drive device for slide cover mechanism as claimed in claim 12, wherein two ends of each drive cord are respectively fixed with two support poles.

31. The synchronous drive device for slide cover mechanism as claimed in claim 17, wherein two ends of each drive cord are respectively fixed with two support poles.

32. The synchronous drive device for slide cover mechanism as claimed in claim 18, wherein two ends of each drive cord are respectively fixed with two support poles.
